(19) United States
(12) Patent Application Publication
(10) Pub. No.: US 2015/0136705 A1
(43) Pub. Date: May 21, 2015

(54) METHOD FOR TREATING HYDROGEN PEROXIDE WATER

(71) Applicant: KURITA WATER INDUSTRIES LTD., Tokyo (JP)

(72) Inventors: Hiroto TOKOSHIMA, Tokyo (JP); Norito IKEMIYA, Tokyo (JP); Hideki KOBAYASHI, Tokyo (JP)

(21) Appl. No.: 14/598,908

(22) Filed: Jan. 16, 2015

Related U.S. Application Data
(63) Continuation of application No. 13/138,745, filed on Dec. 9, 2011.

(30) Foreign Application Priority Data
Apr. 3, 2009 (JP) 2009-091250

(51) Int. Cl. C02F 1/70; B01J 23/42; B01J 31/08; C02F 1/42

(52) U.S. Cl. CPC C02F 1/705; C02F 1/42; B01J 23/42; B01J 31/08; C02F 2101/10
USPC 210/668; 210/750

(57) ABSTRACT

A method for treating drainage containing hydrogen peroxide that has been used for sterilizing and washing an inside of a water treatment system or washing and surface finishing of electronic components includes passing the drainage through the hydrogen peroxide decomposition reactor, injecting effluent water from the hydrogen peroxide decomposition reactor into a side part of the tubular container of the gas-liquid separator, and contacting the drainage with the hydrogen peroxide decomposition catalyst to decompose the hydrogen peroxide in the drainage into oxygen and water, thereby yielding the treated water.

### FIELD OF INVENTION

The present invention relates to a method for treating hydrogen peroxide water. The method yields treated water by decomposing hydrogen peroxide in water to be treated into oxygen and water by causing the water to be treated to contact a hydrogen peroxide decomposition catalyst.

### BACKGROUND OF INVENTION

Conventionally, hydrogen peroxide water is frequently used as an oxidizer, together with a chemical solution such as an acid and an alkali, for washing and surface finishing of electronic components. In addition, hydrogen peroxide water is also used for sterilizing and washing the inside of various water treatment systems, and plays an important role in wet washing.

Since hydrogen peroxide has excellent disinfecting power due to its oxidation power, degradative treatment is required before discharging drainage to outside the system. In addition, when drainage is recovered and recycled, hydrogen peroxide in the drainage affects biological treatment equipment among recovery equipment, so that degradative treatment is required to be carried out beforehand.

Conventionally, a method for detoxifying hydrogen peroxide generally involves decomposing hydrogen peroxide into oxygen and water to carry out treatment. In order to decompose hydrogen peroxide, a method has been adopted which adds a chemical or an enzyme (a catalase) or which cause hydrogen peroxide to contact activated carbon.

However, the method using a chemical or an enzyme requires a reaction tank having a volume sufficient for a predetermined retention time to retain a reaction time, which causes a problem in terms of a space.

In addition, use of an enzyme requires adjustment of pH suitable for enzymatic degradation, which results in a complicated treatment. In addition, since the activated carbon is not sufficiently capable of decomposing hydrogen peroxide, it is unsuited for treating drainage containing relatively highly concentrated hydrogen peroxide on the order of several percent.

In contrast, the present inventors have previously proposed a method for removing hydrogen peroxide in water to be treated by using a hydrogen peroxide decomposition catalyst on which nano-colloidal particles made of a platinum-group metal having an average particle size of 1 to 50 nm are supported (Patent Document 1).

A method using such a hydrogen peroxide decomposition catalyst can efficiently carry out degradative treatment of hydrogen peroxide in water to be treated by passing the water to be treated through a column loaded with the hydrogen peroxide decomposition catalyst. Particularly, in the case of a catalyst in which microparticles made of a nano-colloidal platinum-group metal as proposed in Patent Document 1 are supported on a support, the reaction rate is markedly high and the space velocity (SV) can be increased. Also, since the flow volume is large, an effect of elution of the metal from the catalyst becomes small. In addition, less catalyst is used, and therefore the treatment cost is decreased.

### PRIOR ART DOCUMENT

Patent Document 1: Japanese Patent Publication 2007-185587 A

However, in Patent Document 1, the treatment target is primarily hydrogen peroxide-containing water in a device for producing ultrapure water, and more specifically water containing a tiny amount of hydrogen peroxide having a concentration of about 30 ppb (μg/L), the water being drained from an ultraviolet oxidation treatment device of a device for producing ultrapure water. When the concentration of hydrogen peroxide is high and a large amount of oxygen is generated during decomposition of hydrogen peroxide, there has been no consideration.

That is, in Patent Document 1, hydrogen peroxide-containing water is preferably made to flow downstream through a column loaded with a hydrogen peroxide decomposition catalyst. Then, water effluent from the column is made to pass directly through a device for removing dissolved oxygen, such as a membrane degasifier, to remove oxygen generated during decomposition of hydrogen peroxide.

However, when water to be treated employs hydrogen peroxide-containing drainage having a relatively high concentration of hydrogen peroxide, such as drainage containing hydrogen peroxide on the order of several percent, an amount of oxygen generated during decomposition of hydrogen peroxide is large. Accordingly, if the column effluent water containing such a large amount of oxygen is made to pass directly through a membrane degasifier, etc., the load is too large for a typical membrane degasifier because of a large amount of oxygen to be separated. Therefore, there is a problem that stable operation cannot be carried out.

### OBJECT AND SUMMARY OF INVENTION

### Object of Invention

Accordingly, it is an object of the present invention to solve the problems in the above Patent Document 1 and to provide a device for treating hydrogen peroxide water, the device being capable of carrying out continuous operation and efficient treatment even for drainage containing relatively highly concentrated hydrogen peroxide on the order of several percent and the device having a simple configuration and a relatively compact size.

### SUMMARY OF INVENTION

A method for treating drainage containing hydrogen peroxide that has been used for sterilizing and washing an inside of a water treatment system or washing and surface finishing of electronic components, comprises

preparing a hydrogen peroxide decomposition reactor loaded inside with a hydrogen peroxide decomposition catalyst, and having an inlet for the drainage to be treated and an outlet for treated water;

preparing a gas-liquid separator comprising a tubular container having an exhaust gas piping connected to an upper part of the container, a drainage piping connected to a lower part of the container; and a size such that a linear velocity (LV) of 0.05 to 0.1 m/sec is achieved;

passing the drainage through the hydrogen peroxide decomposition reactor at a space velocity (SV) of 10 to 150 hr⁻¹;

injecting effluent water from the hydrogen peroxide decomposition reactor into a side part of the tubular container of the gas-liquid separator; and

contacting the drainage with the hydrogen peroxide decomposition catalyst to decompose the hydrogen peroxide in the drainage into oxygen and water, thereby yielding the treated water.

A device for treating hydrogen peroxide water according to a first embodiment includes: an inlet for water to be treated; an outlet for treated water; a hydrogen peroxide decomposition reactor loaded inside with a hydrogen peroxide decomposition catalyst; and a gas-liquid separator into which effluent water from the hydrogen peroxide decomposition reactor is injected, the gas-liquid separator including a tubular container having exhaust gas piping connected to an upper part of the container and drainage piping connected to a lower part of the container, wherein the effluent water is injected into a side part of the tubular container, wherein the device for treating hydrogen peroxide water yields the treated water by decomposing hydrogen peroxide in the water to be treated into oxygen and water by causing the water to be treated to contact the hydrogen peroxide decomposition catalyst.

According to a second embodiment, the hydrogen peroxide decomposition catalyst is produced by supporting a platinum-group metal on a support in the device for treating hydrogen peroxide water of the first embodiment.

According to a third embodiment, the platinum-group metal is a nano-colloidal particle made of a platinum-group metal having an average particle size of 1 to 50 nm in the device for treating hydrogen peroxide water of the second embodiment.

According to a fourth embodiment, the support is an ion exchange resin in the device for treating hydrogen peroxide water of the second or third embodiment.

According to a fifth embodiment, a hydrogen peroxide concentration of the water to be treated is between 0.1 and 5% by weight in the device for treating hydrogen peroxide water of any one of the first to third embodiments.

According to a sixth embodiment, the water to be treated is made to flow upstream through the hydrogen peroxide decomposition reactor in the device for treating hydrogen peroxide water of any one of the first to fifth embodiments.

According to a seventh embodiment, the water to be treated is made to pass through the hydrogen peroxide decomposition reactor at a space velocity (SV) of 10 to 500 hr⁻¹ in the device for treating hydrogen peroxide water of any one of the first to sixth embodiments.

### Advantageous Effects of Invention

A device for treating hydrogen peroxide water according to the present invention includes a gas-liquid separator in a step following a hydrogen peroxide decomposition reactor. In this gas-liquid separator, oxygen can be subjected to efficient gas-liquid separation, the oxygen being generated during decomposition of hydrogen peroxide in a hydrogen peroxide decomposition reactor and being included in water effluent from the hydrogen peroxide decomposition reactor.

Because of this, when drainage containing relatively highly concentrated hydrogen peroxide on the order of several percent is treated, a large amount of oxygen generated by decomposing highly concentrated hydrogen peroxide can be smoothly removed outside the system to carry out stable, efficient, and continuous treatment.

In the present invention, as a hydrogen peroxide decomposition catalyst, those produced by supporting a platinum-group metal on a support are preferable because the catalytic activity of decomposing hydrogen peroxide is superior (the second embodiment). In particular, those produced by supporting nano-colloidal particles made of a platinum-group metal having an average particle size of 1 to 50 nm on a support are preferable (the third embodiment). The support preferably employs an ion exchange resin (the fourth embodiment).

Such a device for treating hydrogen peroxide water according to the present invention is effective in treating water containing relatively highly concentrated hydrogen peroxide, such as water having a hydrogen peroxide concentration of 0.1 to 5% by weight.

In addition, when the water containing relatively highly concentrated hydrogen peroxide is treated in such a manner, flowing water to be treated downstream through a hydrogen peroxide decomposition reactor fails to enable a relatively large amount of oxygen foam generated during decomposition of hydrogen peroxide to be efficiently drained from the hydrogen peroxide decomposition reactor. In addition, these foams are retained in a column, which causes drift of the water to be treated. Then, water which does not sufficiently contact a hydrogen peroxide decomposition catalyst flows out from the hydrogen peroxide decomposition reactor. As a result, the residual hydrogen peroxide concentration in the effluent water becomes higher. Thus, the water to be treated is preferably made to flow upstream through the hydrogen peroxide decomposition reactor (the sixth embodiment).

In addition, too low flow rate of the water to be treated causes poor treatment efficiency, but too high one fails to allow hydrogen peroxide in the water to be treated containing highly concentrated hydrogen peroxide to be sufficiently decomposed. Accordingly, the flow rate in the hydrogen peroxide decomposition reactor is preferably set to between 10 and 500 hr⁻¹ as a space velocity (SV) (the seventh embodiment).

### BRIEF DESCRIPTION OF DRAWINGS

FIG. 1 is a systematic diagram showing a device for treating hydrogen peroxide water of an embodiment of the present invention.

### DESCRIPTION OF EMBODIMENTS

Hereinafter, embodiments of a device for treating hydrogen peroxide water of the present invention are described in detail by referring to the Drawings.

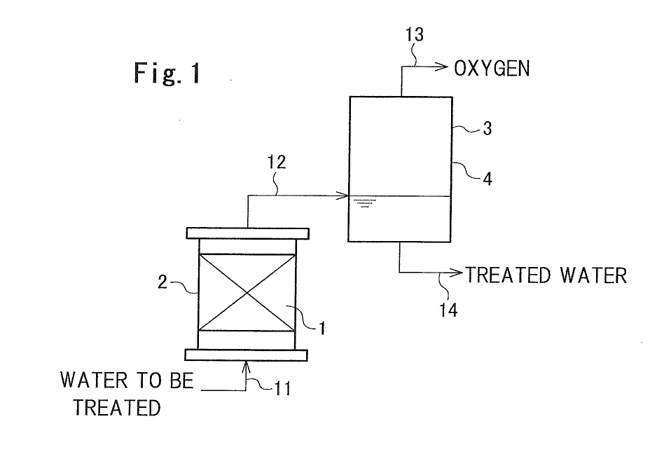

FIG. 1 is a systematic diagram showing a device for treating hydrogen peroxide water of an embodiment of the present invention. In FIG. 1, water to be treated containing hydrogen peroxide flows upstream via piping 11 through a hydrogen peroxide decomposition reactor 2 loaded with a hydrogen peroxide decomposition catalyst 1. Effluent water from the hydrogen peroxide decomposition reactor 2 is injected into a gas-liquid separator 3 from piping 12. Oxygen-containing gas which has been subjected to gas-liquid separation in the gas-liquid separator 3 is exhausted outside the system through exhaust gas piping 13. In addition, treated water is drained outside the system through drainage piping 14.

In the present invention, the water to be treated, which is the treatment target, is hydrogen-peroxide-containing water. The concentration of hydrogen peroxide is, but is not particularly limited to, 0.1 to 5% by weight. For treatment of water to be treated containing such a relatively high concentration of hydrogen peroxide, it is preferable that an effect of a device for treating hydrogen peroxide water of the present invention is effectively exerted, the device including a gas-liquid separator capable of separating oxygen generated during decomposition of hydrogen peroxide.

The hydrogen peroxide decomposition catalyst 1 with which the hydrogen peroxide decomposition reactor 2 is loaded preferably employs, but is not particularly limited to, a hydrogen peroxide decomposition catalyst produced by supporting a platinum-group metal on a support because of excellent catalytic activity of such a hydrogen peroxide decomposition catalyst in a reaction of decomposing hydrogen peroxide. In particular, a catalyst produced by supporting nano-colloidal particles made of a platinum-group metal having an average particle size of 1 to 50 nm on a support is preferable.

Examples of the platinum-group metal as a component having catalytic activity include ruthenium, rhodium, palladium, osmium, iridium, and platinum. Among these platinum-group metals, one can be used solely, or two or more can be combined and used. An alloy made of two or more platinum-group metals can be used. Alternatively, a purified product having a naturally produced mixture can be used without separating into single components. Among the platinum-group metals, platinum, palladium, a platinum/palladium alloy, or a mixture of two or more platinum-group metals can be particularly preferably used due to their strong catalytic activity.

Examples of a method for producing nano-colloidal particles made of a platinum-group metal can include, but are not particularly limited to, a metal-salt reduction reaction method, a combustion method, and the like. Among them, since the metal-salt reduction reaction method is easy to perform and can yield metal nano-colloidal particles having a stable quality, the method can be preferably used. The metal-salt reduction reaction method can produce nano-colloidal particles made of a platinum-group metal by adding 4 to 20 equivalents of a reducing agent such as alcohol, citric acid or salts thereof, formic acid, acetone, and acetaldehyde to an aqueous solution having 0.1 to 0.4 mmol/L of a chloride, nitrate, sulfate, metal complex, or the like of a platinum-group metal such as platinum, and by boiling the mixture for 1 to 3 hours. In addition, for example, hexachloroplatinic acid and/or potassium hexachloroplatinate is dissolved into a polyvinylpyrrolidone aqueous solution at a concentration of 1 to 2 mmol/L. Then, a reducing agent such as ethanol is added thereto, and the mixture is heated under reflux for 2 to 3 hours under a nitrogen atmosphere, thereby producing platinum nano-colloidal particles.

Nano-colloidal particles made of a platinum-group metal as used in the present invention have an average particle size of preferably 1 to 50 nm, more preferably 1.2 to 20 nm, and further preferably 1.4 to 5 nm. When the average particle size of the nano-colloidal particle made of a platinum-group metal is less than 1 nm, the catalytic activity of decomposing and removing hydrogen peroxide may likely decrease. When the average particle size of the nano-colloidal particle made of a platinum-group metal exceeds 50 nm, the catalytic activity of decomposing and removing hydrogen peroxide may likely decrease because the specific surface area of the nano-colloidal particle becomes small.

In the present invention, examples of a support on which nano-colloidal particles made of a platinum-group metal are supported can include, but are not particularly limited to, magnesia, titania, alumina, silica-alumina, zirconia, activated carbon, zeolite, diatom earth, an ion exchange resin, and the like. Among them, the anion-exchange resin can be particularly preferably used. Specifically, since a nano-colloidal particle made of a platinum-group metal has an electric double layer and is negatively charged, the particle is stably supported on the anion-exchange resin and is not readily detached from the resin. In addition, the nano-colloidal particle made of a platinum-group metal which is supported on the anion-exchange resin exhibits a strong catalytic activity of decomposing and removing hydrogen peroxide.

The anion-exchange resin preferably employs a strongly basic anion-exchange resin using a styrene-divinylbenzene copolymer as a base, and more preferably employs a gel resin, in particular. In addition, the exchange group of the anion-exchange resin is preferably an OH-type exchange group. The OH-type anion-exchange resin has an alkaline resin surface, which promotes decomposition of hydrogen peroxide.

In the present invention, the supported amount of the nano-colloidal particle made of a platinum-group metal which is supported on a support such as an anion-exchange resin is preferably between 0.01 and 0.2% by weight, and more preferably between 0.04 and 0.1% by weight. When the supported amount of the nano-colloidal particle made of a platinum-group metal is less than 0.01% by weight, the catalytic activity of decomposing and removing hydrogen peroxide may likely become insufficient. When the supported amount of the nano-colloidal particle made of a platinum-group metal is 0.2% by weight or less, the particle exhibits catalytic activity sufficient to decompose and remove hydrogen peroxide. Thus, there is usually no need to support metal nano-colloidal particles in an amount of more than 0.2% by weight. In addition, an increase in the supported amount of the metal nano-colloidal particle may increase the possibility of elution of the metal into water.

A component material of the hydrogen peroxide decomposition reactor 1 into which such a hydrogen peroxide decomposition catalyst 2 is packed preferably uses, but is not particularly limited to, materials having heat resistance because the heat of the reaction due to hydrogen peroxide decomposition may elevate the water temperature by 3 to 35° C. depending on the concentration of hydrogen peroxide in the water to be treated. Since FRP (fiber reinforced plastic), polyethylene, heat-resistant polyvinyl chloride, etc., have both heat-resistance and strength, one of these materials is preferably used.

As described previously, the decomposition of hydrogen peroxide generates oxygen and water according to the following reaction formula:

2H₂O₂→O₂+2H₂O.

Accordingly, immediately after the injection of water to be treated into the hydrogen peroxide decomposition reactor 2, oxygen is generated and oxygen foaming occurs inside the hydrogen peroxide decomposition reactor 2. Thus, the orientation of flow of the water to be treated in the hydrogen peroxide decomposition reactor 2 is preferably upstream so as to enable the foam to be readily exhausted. Therefore, the hydrogen peroxide decomposition reactor 2 as shown in FIG. 1 has an inlet for the water to be treated at the bottom and an outlet for treated water at the top.

In addition, when the flow rate of the water to be treated that is being injected into the hydrogen peroxide decomposition reactor 2 is too low, the treatment efficiency is poor. However, when the flow rate is too high, a portion of the hydrogen peroxide remains undecomposed and is drained. So, the flow rate is preferably between 10 and 500 hr⁻¹, and particularly preferably between 10 and 150 hr⁻¹ as a space velocity (SV) per volume of a hydrogen peroxide decomposition catalyst.

Water effluent from the hydrogen peroxide decomposition reactor 2 is injected into the gas-liquid separator 3 via the piping 12, and is subjected to gas-liquid separation.

The gas-liquid separator 3 as shown in FIG. 1 preferably includes a tubular container 4, wherein the exhaust gas piping 13 is connected to the upper part; the drainage piping 14 is connected to the lower part; and the piping 12 for water effluent from the hydrogen peroxide decomposition reactor 2 is connected to the side part of this tubular container 4. Such a gas-liquid separator 3 can carry out efficient gas-liquid separation by using an inexpensive gas-liquid separator having a simple configuration and a compact size.

With regard to the size and volume of the tubular container 4 of the gas-liquid separator 3 and the tube diameters of the exhaust gas piping 13 and the drainage piping 14, there are preferable ranges for achieving efficient gas-liquid separation while maintaining the retention time in the tubular container 4. For example, it is preferable to use the following set-up.

Tubular container (in the case of a cylindrical container)

Inner diameter: An inner diameter with which a linear velocity (LV) of 0.05 to 0.1 m/sec is achieved.

Height h from the bottom of the container to the connection portion of the effluent water piping 12: A height for the top of water to produce a pressure having 1 to 3 fold pressure loss at the draining part of the container for draining treated water

Total height of the container: 2 to 5 times the above height h

(In addition, in the case of a tubular container other than cylindrical one, the cross-section size is designed so as to satisfy the linear velocity.)

Tube diameter (inner diameter) of the drainage piping 14: 0.5 to 1.5 times the inner diameter of the tubular container (cylindrical container).

Tube diameter (inner diameter) of the exhaust gas piping 13: 0.2 to 1.0 times the tube diameter of the drainage piping 14.

In addition, examples of a component material of this tubular container 4 which is preferably used include FRP (fiber reinforced plastic), polyethylene, heat-resistant polyvinyl chloride, and the like because of reasons similar to the reasons for using these materials in the hydrogen peroxide decomposition reactor.

In such a gas-liquid separator 3, oxygen in water effluent from the hydrogen peroxide decomposition reactor is subjected to efficient gas-liquid separation. The separated oxygen is exhausted through the exhaust gas piping 13, and treated water is drained through the drainage piping 14.

The oxygen exhausted through the exhaust gas piping 13 of the gas-liquid separator 3 is high-purity oxygen. So, when discharged to outside the system, the oxygen is preferably kept away from fire in accordance with safety procedures for handling a combustion-supporting gas. In addition, the oxygen is preferably diluted with an inert gas such as nitrogen having a concentration of 20% or less in order to be exhausted. This oxygen can be utilized in other processes, for example, it can be utilized as an aeration gas for an aerobic biological treatment tank.

The treated water drained through the drainage piping 14 is water having a high concentration of dissolved oxygen. The treated water is drained outside the system by carrying out secondary treatment such as deoxygenation treatment using aeration depending on the need, or the treated water is recycled as industrial water, etc.

### EXAMPLES

Hereinafter, the present invention is more specifically described by referring to an Example and a Comparative Example.

### Example 1

Treatment of hydrogen peroxide-containing drainage was carried out using a device for treating hydrogen peroxide water as shown in FIG. 1.

The configuration of the respective parts of the device used for treating hydrogen peroxide water is as follows.

Hydrogen peroxide decomposition reactor: A column made of polyethylene (diameter: 100 mm, length: 600 mm) was packed with 3 L of “Nanosaver S”, manufactured by KURITA WATER INDUSTRIES LTD., as a hydrogen peroxide decomposition catalyst (platinum nano-colloidal particles having an average particle size of 2 nm and having a supported amount of 0.1% by weight were supported on a strongly basic gel-type anion-exchange resin).

Gas-liquid separator: drainage piping having an inner diameter of 25 mm and exhaust gas piping having an inner diameter of 10 mm were connected to a column made of heat-resistant polyvinyl chloride (diameter: 40 mm, height: 300 mm). Effluent water piping of the hydrogen peroxide decomposition reactor was connected to a position having a height of 100 mm from the bottom of the column (a position at the one-third of the total height).

As water to be treated, five kinds of hydrogen peroxide-containing drainage having the hydrogen peroxide concentrations of 0.1% by weight, 0.5% by weight, 1% by weight, 3% by weight, and 5% by weight were used. For the respective drainage, treatment was carried out in a flow volume of 5 L/min. The space velocity (SV) in the hydrogen peroxide decomposition reactor was 100 hr⁻¹.

The concentration of hydrogen peroxide in the resulting treated water (water separated in the gas-liquid separator) was determined with a hydrogen peroxide test paper, “Checkl KS”, manufactured by KURITA WATER INDUSTRIES LTD. (the lower limit for measurement is 3 mg/L).

The results demonstrated that for water to be treated having any of the hydrogen peroxide concentrations, the concentration of hydrogen peroxide in treated water is the lower limit for measurement or less. In addition, the time required for the treatment (the time required from injection into a hydrogen peroxide decomposition reactor to draining by passing through a gas-liquid separator) was about 50 seconds. Any of from less concentrated hydrogen peroxide-containing drainage to highly concentrated hydrogen peroxide-containing drainage was subjected to efficient degradative treatment of hydrogen peroxide in a short time by using a device having a simple configuration for treating hydrogen peroxide water. Then, high-quality treated water was able to be yielded.

### Comparative Example 1

The hydrogen peroxide-containing drainage having the respective concentrations as treated in Example 1 was once stored in each retention tank having a volume of 30 L. To this retention tank was added an enzyme (a catalase), and the mixture was uniformly stirred with a stirrer to carry out decomposition of hydrogen peroxide by the enzyme. In order to retain a certain reaction time, the treatment required about 6 minutes (the time required from injection into a retention tank and addition of an enzyme while stirring to draining from the retention tank). Therefore, the treatment time was prolonged, as well as the device used a complicated one.

Although the present invention has been illustrated by using specific embodiments, it is obvious to those skilled in the art that various modifications are possible without departing the spirit and scope of the present invention.

In addition, the present application claims benefit of a Japanese patent application (Japanese Patent Application No. 2009-091250) filed on Apr. 3, 2009, which is herein Incorporated by reference in its entirety.

1. A method for treating drainage containing hydrogen peroxide that has been used for sterilizing and washing an inside of a water treatment system or washing and surface finishing of electronic components, comprising:
preparing a hydrogen peroxide decomposition reactor loaded inside with a hydrogen peroxide decomposition catalyst, and having an inlet for the drainage to be treated and an outlet for treated water;
preparing a gas-liquid separator comprising a tubular container having
an exhaust gas piping connected to an upper part of the container,
a drainage piping connected to a lower part of the container; and
a size such that a linear velocity (LV) of 0.05 to 0.1 m/sec is achieved;
passing the drainage through the hydrogen peroxide decomposition reactor at a space velocity (SV) of 10 to 150 hr⁻¹;
injecting effluent water from the hydrogen peroxide decomposition reactor into a side part of the tubular container of the gas-liquid separator; and
contacting the drainage with the hydrogen peroxide decomposition catalyst to decompose the hydrogen peroxide in the drainage into oxygen and water, thereby yielding the treated water.

2. The method for treating drainage containing hydrogen peroxide according to claim 1, further comprising supporting a platinum-group metal on a support, thereby producing the hydrogen peroxide decomposition catalyst.

3. The method for treating drainage containing hydrogen peroxide according to claim 2, wherein the platinum-group metal is a nano-colloidal particle made of a platinum-group metal having an average particle size of 1 to 50 nm.

4. The method for treating drainage containing hydrogen peroxide according to claim 2, wherein the support is an ion exchange resin.

5. The method for treating drainage containing hydrogen peroxide according to claim 1, wherein a hydrogen peroxide concentration of the drainage is between 0.1 and 5% by weight.

6. The method for treating drainage containing hydrogen peroxide according to claim 1, further comprising flowing the drainage upward through the hydrogen peroxide decomposition reactor.

7. The method for treating drainage containing hydrogen peroxide according to claim 1, further comprising flowing the drainage in the tubular container at the linear velocity (LV) of 0.05 to 0.1 m/sec.

8. The method for treating drainage containing hydrogen peroxide according to claim 1, wherein the side part of the tubular container comprises an effluent water piping connected thereto,
wherein the tubular container has
an inner diameter with which the linear velocity (LV) of 0.05 to 0.1 m/sec is achieved,
a height h from a bottom of the tubular container to a connection portion of the effluent water piping such that a height for a top of water produces a pressure having 1 to 3 fold pressure loss at a draining part of the tubular container for draining the treated water, and
a total height of the tubular container is 2 to 5 times the height h.

9. The method for treating drainage containing hydrogen peroxide according to claim 8, wherein the drainage piping has an inner diameter of 0.5 to 1.5 times an inner diameter of the tubular container.

10. The method for treating drainage containing hydrogen peroxide according to claim 9, wherein the exhaust gas piping has an inner diameter of 0.2 to 1.0 times a tube diameter of the drainage piping.

11. A method for treating drainage containing hydrogen peroxide that has been used for sterilizing and washing an inside of a water treatment system or washing and surface finishing of electronic components, comprising:
preparing a hydrogen peroxide decomposition reactor loaded inside with a hydrogen peroxide decomposition catalyst, and having an inlet for the drainage to be treated and an outlet for treated water;
preparing a gas-liquid separator comprising a tubular container having
an exhaust gas piping connected to an upper part of the container, and
a drainage piping connected to a lower part of the container;
passing the drainage through the hydrogen peroxide decomposition reactor at a space velocity (SV) of 10 to 150 hr⁻¹;
injecting effluent water from the hydrogen peroxide decomposition reactor into a side part of the tubular container of the gas-liquid separator; and
contacting the drainage with the hydrogen peroxide decomposition catalyst to decompose the hydrogen peroxide in the drainage into oxygen and water, thereby yielding the treated water,
wherein a hydrogen peroxide concentration of the drainage is between 0.1 and 5% by weight.

12. The method for treating drainage containing hydrogen peroxide according to claim 11, wherein the side part of the tubular container comprises an effluent water piping connected thereto,
wherein the tubular container has
an inner diameter with which the linear velocity (LV) of 0.05 to 0.1 m/sec is achieved,
a height h from a bottom of the tubular container to a connection portion of the effluent water piping such that a height for a top of water produces a pressure having 1 to 3 fold pressure loss at a draining part of the tubular container for draining the treated water, and
a total height of the tubular container is 2 to 5 times the height h.

13. The method for treating drainage containing hydrogen peroxide according to claim 12, wherein the drainage piping has an inner diameter of 0.5 to 1.5 times an inner diameter of the tubular container.

14. The method for treating drainage containing hydrogen peroxide according to claim 13, wherein the exhaust gas piping has an inner diameter of 0.2 to 1.0 times a tube diameter of the drainage piping.
